(19) United States
(12) Patent Application Publication
(10) Pub. No.: US 2008/0241563 A1
(43) Pub. Date: Oct. 2, 2008

(54) POLYMER SUBSTRATE FOR ELECTRONIC COMPONENTS

(76) Inventors: Khamvong Thammasouk, San Jose, CA (US); Polsak Lertputipinyo, Bangkok (TH)

Correspondence Address: SYNAPTICS C/O WAGNER BLECHER LLP, 123 WESTRIDGE DRIVE, WATSONVILLE, CA, 95076, US

(21) Appl. No.: 12/056,121

(22) Filed: Mar. 26, 2008

Related U.S. Application Data
(60) Provisional application No. 60/921,159, filed on Mar. 30, 2007.

(51) Int. Cl. B32B 27/36; B29C 65/00; B05D 5/12

(52) U.S. Cl. 428/480; 156/60; 427/126.1

(57) ABSTRACT

In one embodiment, the present invention comprises a method for fixedly and electronically coupling an electronic component to a polymer substrate. In this embodiment, a polymer substrate is received. The polymer substrate has an electronic component disposed proximate a bonding agent which is coupled to the polymer substrate. The present embodiment also provides a heat shielding fixture which is configured to shield at least a portion of the polymer substrate from a heat source. The heat shielding fixture is configured to allow heat from the heat source to access the bonding agent. The present embodiment then subjects the bonding agent to the heat source such that the heat from the heat source causes the electronic component to be fixedly and electronically coupled to the polymer substrate once the bonding agent solidifies.

### RELATED U.S. APPLICATION

This application claims priority to the copending provisional patent application Ser. No. 60/921,159, Attorney Docket Number SYNA-20070201-A1.PRO, entitled “Polymer Substrate for Electronic Components,” with filing date Mar. 30, 2007, assigned to the assignee of the present application, and hereby incorporated by reference in its entirety.

### BACKGROUND

Surface mount technologies and fabrication processes have existed for decades. However, as various technologies evolve and improve, surface mount technologies and fabrication processes must also evolve and improve to meet the increased manufacturing demands. These increased demands can be in the form of greater throughput, higher yield, reduced cost, or any combination thereof.

One attempt to improve surface mount technologies and fabrication processes has employed the use of flexible substrates. Flexible substrate methodologies typically involve mounting of electronic components onto a flexible substrate formed of a polyimide material such as, for example, Kapton™ tape produced by E. I. Du Pont De Nemours and Company of Wilmington, Del. While conventional flexible substrates provide significant advantages in various applications, conventional flexible substrates are not without drawbacks.

As mentioned above, conventional flexible substrates are typically formed of high melting point materials such as polyimide materials (e.g. Kapton™ tape) which have been thought to be compatible with the high temperatures associated with standard surface mount technologies and fabrication processes. Unfortunately, such polyimide materials tend to be quite expensive. As such, flexible substrates are not always a feasible solution for applications in which cost is an important factor.

In an effort to reduce the costs associated with flexible substrates, attempts have been made to integrate the use of flexible substrates with more conventional and less expensive standard printed circuit board (PCB) substrates. In such an approach, some portion of the required components and circuitry are mounted on the flexible substrate and some other portion of the required components and circuitry are mounted on the rigid PCB. The flexible substrate is then coupled to the PCB. The point at which the flexible substrate is coupled to the rigid PCB tends to experience significant stress (due to the mismatch of the rigidity between the flexible substrate and the rigid PCB) and is often a failure point in the assembly. While reinforcement of the coupling between the flexible substrate and the rigid PCB has been suggested and tried, such reinforcement introduces additional expense into the manufacturing process.

Thus, it would be advantageous to derive the benefits of flexible substrates without incurring the increased costs associated with conventional flexible substrate material. Furthermore, it would be advantageous to derive the benefits of flexible substrates without requiring the failure-prone coupling of the flexible substrate to a rigid substrate.

### SUMMARY

In one embodiment, the present invention comprises a method for fixedly and electronically coupling an electronic component to a polymer substrate. In this embodiment, a polymer substrate is received. The polymer substrate has an electronic component disposed proximate a bonding agent which is coupled to the polymer substrate. The present embodiment also provides a heat shielding fixture which is configured to shield at least a portion of the polymer substrate from a heat source. The heat shielding fixture is configured to allow heat from the heat source to access the bonding agent. The present embodiment then subjects the bonding agent to the heat source such that the heat from the heat source causes the electronic component to be fixedly and electronically coupled to the polymer substrate once the bonding agent solidifies.

### BRIEF DESCRIPTION OF THE DRAWINGS

FIG. 1 is a perspective view of a polymer substrate having bonding pads and a conductive trace coupled thereto in accordance with embodiments of the present invention.

FIG. 2 is a flow chart describing a method for fixedly coupling an electronic component to a polymer substrate in accordance with embodiments of the present invention.

FIG. 3 is an exploded perspective view of an assembly comprised of polymer substrate having an electronic component disposed proximate a bonding agent, and a polymer substrate-protecting heat shielding fixture in accordance with embodiments of the present invention.

FIG. 4 is a perspective view of the assembly of FIG. 3 with the back plane and the front plane aligned together with the polymer substrate disposed there between in accordance with embodiments of the present invention.

FIG. 5 is an exploded perspective view of an assembly partially comprised of a polymer substrate having a plurality of electronic components disposed proximate a bonding agent, and a polymer substrate-protecting heat shielding fixture in accordance with embodiments of the present invention.

FIG. 6 is a perspective view of the assembly of FIG. 5 with the back plane and the front plane aligned together with the polymer substrate disposed there between in accordance with embodiments of the present invention.

FIG. 7 is a perspective view of a polymer substrate which is folded to produce a multilayer assembly in accordance with embodiments of the present invention.

FIG. 8 is a side view of a polymer substrate having electronic components coupled to both a first side and a second side of the polymer substrate in accordance with embodiments of the present invention.

FIG. 9 is a perspective view of an electronic assembly comprising a polyester substrate having a capacitive sensing device and a plurality of electronic components coupled thereto in accordance with embodiments of the present invention.

FIG. 10 is a flow chart describing a method for masking an exposed metallic layer disposed on a polyester substrate in accordance with embodiments of the present invention.

FIG. 11A is a side view of polyester substrate having a metallic layer disposed there above in accordance with embodiments of the present invention.

FIG. 11B is a side view of polyester substrate having a metallic layer disposed there above with a masking disposed above a portion of the metallic layer in accordance with embodiments of the present invention.

FIG. 12 is a flow chart describing a method for surface finishing an exposed metallic region disposed on a polyester substrate in accordance with embodiments of the present invention.

FIG. 13 is a side view of polyester substrate having a metallic layer disposed there above with a portion of the metallic layer subjected to a surface finishing process in accordance with embodiments of the present invention.

The drawings referred to in this description should not be understood as being drawn to scale except if specifically noted.

### DETAILED DESCRIPTION

Reference will now be made in detail to embodiments of the invention, examples of which are illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

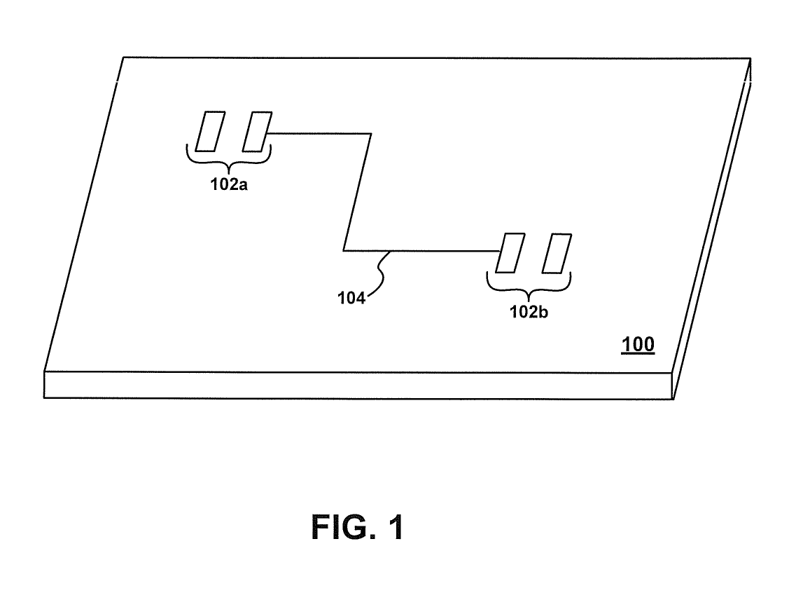

Referring now to FIG. 1, a perspective view of a polymer substrate 100 is shown. In the embodiment of FIG. 1, polymer substrate also has a first set of bonding pads 102a and a second set of bonding pads 102b coupled thereto. Embodiments in accordance with the present invention are also well suited to having any of various types of intermediary layers disposed between polymer substrate 100 and bonding pads 102a and/or 102b. In the present embodiment first set of bonding pads 102a and second set of bonding pads 102b are coupled via a conductive trace 104. In the embodiment of FIG. 1, for purposes of clarity and brevity, only two sets of bonding pads 102a and 102b and only a single connecting conductive trace 104 are shown coupled to polymer substrate 100. It will be understood that the present invention is also well suited to embodiments in which a smaller or significantly greater number of bonding pads and corresponding conductive traces are coupled to polymer substrate 100. Additionally, embodiments of the present invention are well suited to having bonding pads 102a and 102b and conductive trace 104 formed using any of numerous well known bonding pad and/or conductive trace manufacturing processes such as, but not limited to, screen printing or photolithography processes. Furthermore, in one embodiment, polymer substrate 100 is comprised of a polyester material such as, but not limited to, for example, polyethylene terephthalate (PET) or polyethylene naphthalate (PEN). Additionally, in various embodiments in accordance with the present invention, polymer substrate 100 is comprised of a thermoplastic material. Also, in various embodiments described herein, the polymer substrate has a thickness in the range of approximately 25-200 micrometers.

For purposes of clarity and brevity, the later figures also show fewer sets of bonding pads 102a and 102b and only a single connecting conductive trace 104 are shown coupled to polymer substrate 100.

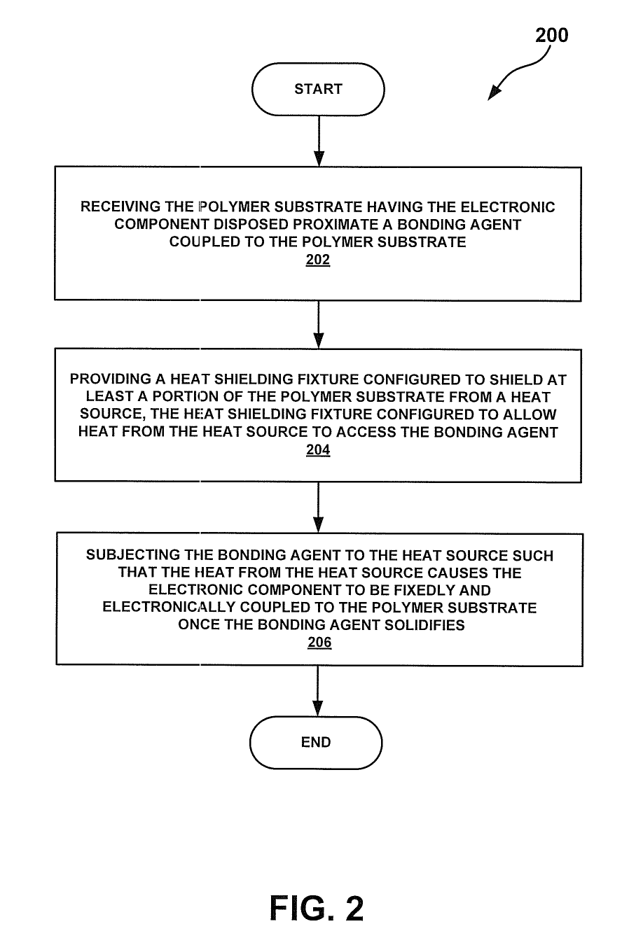

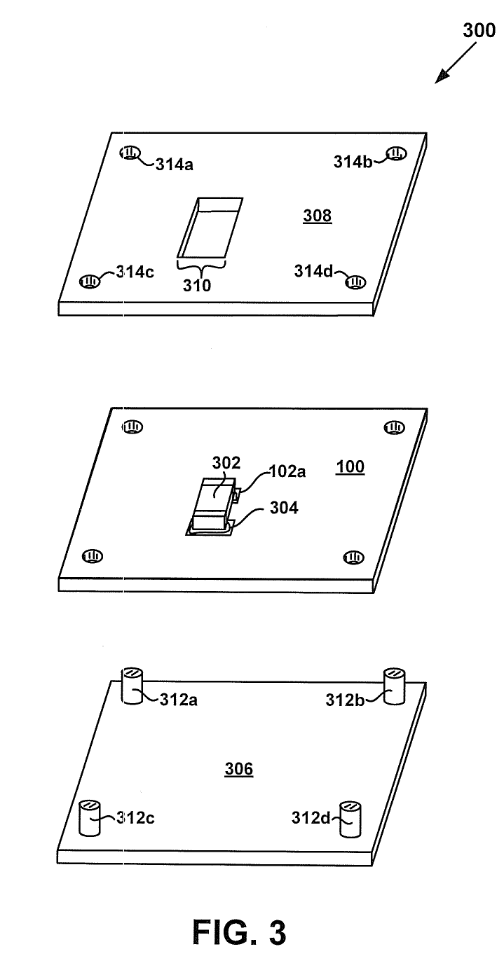

With reference now to FIG. 2, a flow chart 200 describing a method for fixedly coupling an electronic component to a polymer substrate is provided. At 202, the method of the present embodiment receives a polymer substrate having an electronic component disposed proximate a bonding agent coupled to the polymer substrate. Hence, in one embodiment, the present method receives a polymer substrate such as, for example, polymer substrate 100 of FIG. 1. In such an embodiment, an electronic component would be coupled to, for example, bonding pads 102a using a bonding agent such as, but not limited to, a solder paste material. A concise and illustrative depiction of a polymer substrate having an electronic component disposed proximate a bonding agent coupled to the polymer substrate is provided in FIG. 3, which will be described further in conjunction with the discussion of 204 of FIG. 2. FIG. 3 is an exploded perspective view of an assembly 300 partially comprised of polymer substrate 100 and having an electronic component 302 disposed proximate a bonding agent 304.

At 204, the present embodiment provides a heat shielding fixture configured to shield at least a portion of the polymer substrate from a heat source. For purposes of the present application, the heat shielding fixture shields at least a portion of the polymer substrate from the heat source by shielding at least a portion of the polymer substrate from heat generated by the heat source. In order to more clearly describe 204 of FIG. 2, refer again to FIG. 3. Included in assembly 300 of FIG. 3 is a polymer substrate-protecting heat shielding fixture comprised of a back plane 306 and front plane 308. It should further be noted that the polymer substrate-protecting heat shielding fixture also includes an alignment mechanism configured to align back plane 306 and front plane 308. In the present embodiment, the alignment mechanism is comprised of protrusions 312a-312d of back plane 306, and receiving features 314a-314d of front plane 308. In one embodiment, removable coupling of back plane 306 and front plane 308 is accomplished by inserting protrusions 312a-312d into corresponding receiving features 314a-314d. Although four protrusions and receiving features of circular cross-section are shown in FIG. 3, it is understood that any number and type of appropriate alignment mechanism, having any number or shapes, can be used. For example, although such an alignment mechanism is described herein, the present invention is well suited to embodiments including, but not limited to, pins, holes, slots, guides, and a hinge assembly or any of various other mechanisms or methods to align back plane 306 and front plane 308. Active mechanism may also be used to locate different alignments. For example, a robotic system may place the substrate in alignment with the substrate protecting heat shielding fixture.

Referring still to 204 of FIG. 2 and to FIG. 3, in the present embodiment, the polymer substrate-protecting heat shielding fixture is configured to allow heat from a heat source to access bonding agent 304. More specifically, front plane 308 of the polymer substrate-protecting heat shield fixture has an opening 310 formed therein. Opening 310 is located and oriented such that when back plane 306 and front plane 308 are aligned together with polymer substrate 100 disposed there between, electronic component 302 and bonding agent 304 are able to receive heat from a heat source. Also, in embodiments in accordance with the present invention, the heat source is a single-stage heat source. Hence, embodiments in accordance with the present invention enable fixedly coupling an electronic component to a polymer substrate without requiring the use of a multi-stage heating source.

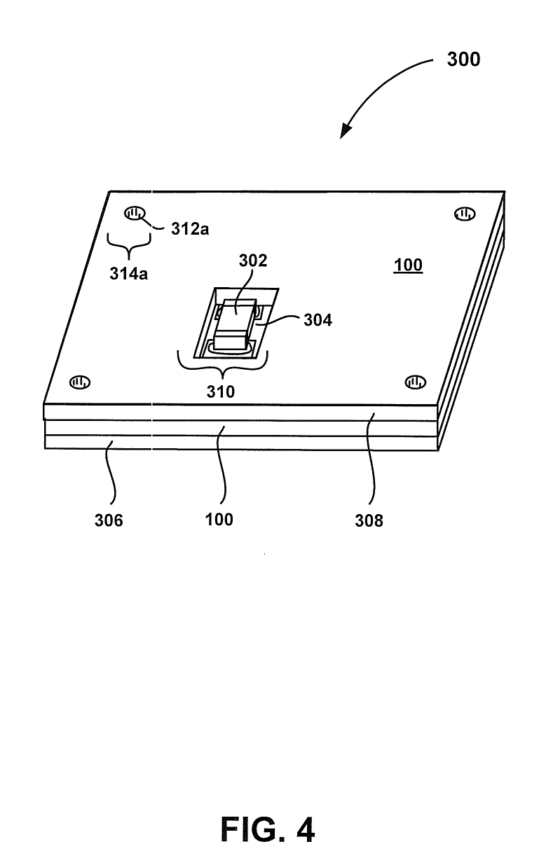

FIG. 4 provides a perspective view of assembly 300 with back plane 306 and front plane 308 aligned together with polymer substrate 100 disposed there between. As shown in FIG. 4, electronic component 302 and bonding agent 304 are located within opening 310 in front plane 308 such that bonding agent 304 is able to receive heat when positioned proximate a heat source.

Referring now to 206 of FIG. 2, the present method then subjects bonding agent 304 to a heat source. When subjected to a heat source such as, for example, an infrared reflow oven, heat from the heat source will cause the bonding agent 304 to activate, reflow or melt. Although an infrared heat source is mentioned above, the present invention is well suited to embodiments in which heat is provided by other sources such as, but not limited to, a vapor reflow system, a hot air reflow system, and the like. Once bonding agent 304 is no longer subjected to heat from the heat source, bonding agent 304 will solidify. Once bonding agent 304 is solidified, the solidified bonding agent will fixedly and electrically couple the electronic component to polymer substrate 100. It will be understood that the electronic component is typically electrically and fixedly coupled to a bonding pad or bonding pads coupled to polymer substrate 100 such as, for example, bonding pads 102a of FIG. 1.

It is understood that the steps of process 200 can be repeated any number of times to produce a final product. For example, steps 202, 204, 206 can all be repeated with the same polymer substrate for various reasons. In one embodiment, these three steps are repeated to bond different electronic components. In this embodiment, for each repetition of step 202, the same polymer substrate with a different unbonded electronic component is provided. As for each repetition of step 204, a different one of a set of different polymer substrate-protecting heat shielding fixtures, each fixture having a different opening for exposing a different electronic component, is used. In this case, a polymer substrate-protecting heat shielding fixtures used in a later repetition would have one or more recesses or other features to accommodate and shield any already-bonded electronic components. In this embodiment, the repetitions of step 206 can be performed under same or different conditions (e.g. temperature, humidity, duration, etc.) as appropriate.

As another example, only steps 204 and 206 are repeated. In one embodiment, these two steps are repeated with the same set of electronic components on the same polymer substrate to bond the set of electronic components to the polymer substrate. For each repetition of step 204, a different polymer substrate-protecting heat shielding fixture may also be used, each having different recesses or other features that accommodate and shield or expose particular electronic components. The repetitions of step 206 can be performed under same or different conditions (e.g. temperature, humidity, duration, etc.) as appropriate.

The process shown in FIG. 2, optionally with repetitions of any or all steps of FIG. 2, can be used to bond electronic components to both sides of a polymer substrate. The recesses and openings of each polymer substrate-protecting heat shielding fixture can be on either or both of the front and back planes, and accommodate and shield or expose components on one or both sides of the polymer substrate. The bonding of electronic components to both sides of the substrate can take place during a single performance of the steps of process 200, or with repetitions of the steps of process 200.

Additionally embodiments in accordance with the present invention are well suited to use with various types of bonding agents for use as bonding agent 304. As an example, one embodiment in accordance with the present invention utilizes a bonding agent comprised of a conventional or standard solder having a melting point of approximately 270 degrees Celsius. Another embodiment in accordance with the present invention utilizes a bonding agent comprised of a “low temperature” solder having a melting point of approximately 120 degrees Celsius. Embodiments in accordance with the present invention are also well suited to using various other bonding agents having various other melting temperatures. Embodiments in accordance with the present invention are also well suited to using bonding agents which are not comprised of solder.

Moreover, in the present embodiment, front plane 308 is configured to shield at least a portion of the front surface (i.e. the surface on which bonding agent 304 and electronic component 302 are disposed) of polymer substrate 100 from heat generated by the heat source. Specifically, that portion of the front surface of polymer substrate 100 which is not exposed by opening 310, when back plane 306 and front plane 308 are aligned together with polymer substrate 100 disposed there between, is shielded from heat generated by a proximately located heat source. As a result, the shielded portion of polymer substrate 100 is not subjected to the high temperatures necessary to reflow or melt or activate bonding agent 304. Hence, embodiments in accordance with the present invention enable polymer substrate 100 to be formed of materials which previously were not possible to use as a substrate. That is, embodiments in accordance with the present invention enable polymer substrate 100 to be formed of materials such as, for example, polyethylene terephthalate (PET) or polyethylene naphthalate (PEN). Additionally, in various embodiments in accordance with the present invention, polymer substrate 100 is comprised of a thermoplastic material. It should be understood, that prior to the development of the embodiments of the present invention, it was not possible, and was, in fact, believed to be impossible, to use materials such as PET and PEN as the substrate in a surface mount technology (SMT) manufacturing process.

During conventional SMT manufacturing processes, reflow temperatures range from approximately 120 degrees Celsius for lower melting point solder to 270 degrees for standard solder. In contrast, the glass transition temperature of PET is approximately 79 degrees Celsius. It will be understood that the glass transition temperature is the temperature above which an amorphous material (such as PET, PEN, and the like) behaves like a liquid (i.e. acquires a rubbery state). Hence, prior to the embodiments in accordance with the present invention, a polyester substrate such as PET would acquire a rubbery state, could suffer from curling or warping, and ultimately would be unsuitable for use as a substrate in an SMT process.

In embodiments in accordance with the present invention, the polymer substrate-protecting heat shielding fixture provides structural rigidity to polymer substrate 100 during heating of bonding agent 304. Specifically, the present polymer substrate-protecting heat shielding fixture rigidly retains polymer substrate 100 between back plane 306 and front plane 308 once back plane 306 and front plane 308 are aligned together with polymer substrate 100 disposed there between. In so doing, even when a portion of polymer substrate 100 (which is exposed by opening 310 of front plane 308) is subjected to a temperature greater than its glass transition temperature, the exposed portion of the polymer substrate 100 does not suffer from curling, warping, or other unwanted deformation. Instead, the present polymer substrate-protecting heat shielding fixture retains polymer substrate 100 in a fixed orientation even during the reflow process. That is, the portions of polymer substrate 100 which are shielded from the heat by back plane 306 and front plane 308 constrain those portions of polymer substrate 100 which are not shielded from heat generated by the heat source. As a result, even when the portion of polymer substrate 100 which is exposed through opening 310 is heated above its glass transition temperature, the surrounding shielded portions of polymer substrate 100 (which are not heated above the glass transition temperature) constrain the shape of the exposed portion of polymer substrate 100 and ensure that the exposed portion does not suffer from curling, warping, or other unwanted deformation. Hence, embodiments in accordance with the present invention enable polymer substrate 100 to be formed of materials which previously were not possible to use as a substrate. That is, embodiments in accordance with the present invention enable polymer substrate 100 to be formed of materials such as, for example, polyethylene terephthalate (PET) or polyethylene naphthalate (PEN), or other thermo-plastic materials which have a glass transition temperature which is less than the temperatures associated with SMT manufacturing processes.

Additionally, the polymer substrate-protecting heat shielding fixture enables fixedly coupling an electronic component to a polymer substrate without subjecting the electronic component and the polymer substrate to an active cooling process subsequent to exposing the bonding agent to the heat source. That is, by using a polymer substrate-protecting heat shielding fixture, polymer substrate 100 is sufficiently shielded from heat such that polymer substrate 100 can have an electronic component coupled thereto without requiring an active cooling process subsequent to exposing the bonding agent to the heat source.

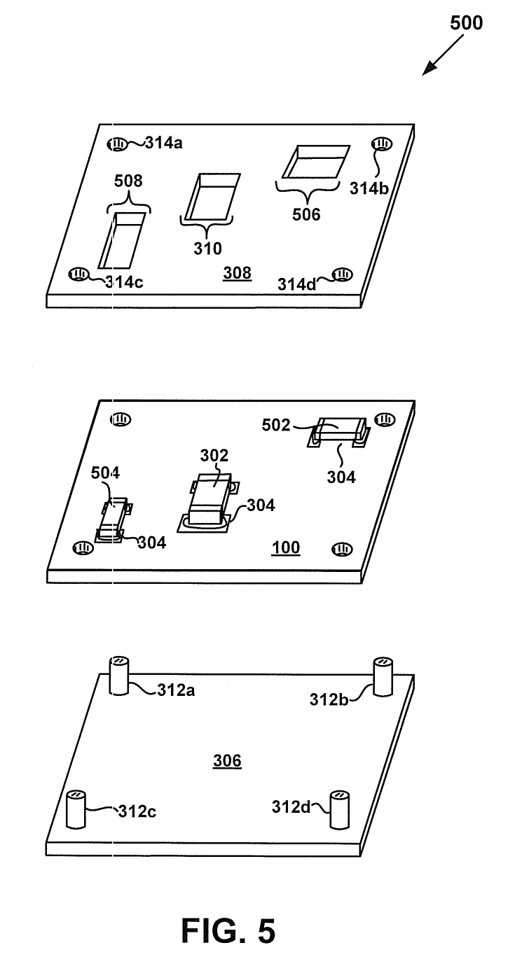

Referring now to FIG. 5, an exploded perspective view of an assembly 500 partially comprised of polymer substrate 100 having a plurality of electronic components 302, 502, and 504 disposed proximate a bonding agent 304 is shown. Included in assembly 500 of FIG. 5 is a polymer substrate-protecting heat shielding fixture comprised of a back plane 306 and front plane 308. More specifically, front plane 308 of polymer substrate-protecting heat shielding fixture has openings 310, 506, and 508 formed therein. Openings 310, 506, and 508 are located and oriented such that when back plane 306 and front plane 308 are aligned together with polymer substrate 100 disposed there between, electronic components 302, 502, and 504 and bonding agent 304 are able to receive heat from a heat source.

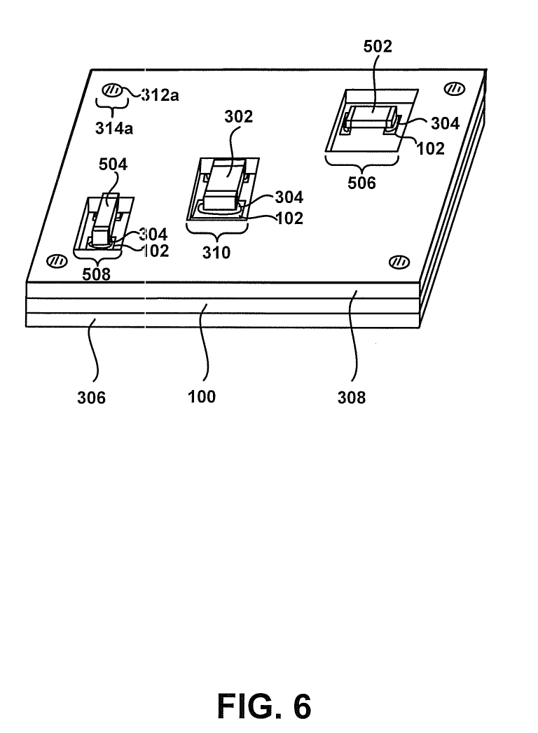

FIG. 6 provides a perspective view of assembly 500 with back plane 306 and front plane 308 aligned together with polymer substrate 100 disposed there between. As shown in FIG. 6, electronic components 302, 502 and 504 (and corresponding bonding agent 304) are located within openings 310, 506, and 508, respectively, in front plane 308 such that bonding agent 304 is able to receive heat when positioned proximate a heat source. Hence, embodiments in accordance with the present invention provide a customized heat shielding fixture which is particularly configured to shield at least a portion of a polymer substrate from a heat source while still allowing heat from the heat source to access a bonding agent. More specifically, embodiments in accordance with the present invention provide a heat shielding fixture which is particularly configured to shield at least a portion of polymer substrate 100 from a heat source while still allowing heat from said heat source to access a plurality of locations on polymer substrate 100 at which electronic components (302, 502, and 504) are disposed proximate a bonding agent 304 coupled to polymer substrate 100. Assembly 500 operates and is utilized in the manner as described above in conjunction with the description of FIGS. 3 and 4, and such description is not repeated here for purposes of brevity and clarity.

As stated above, the assembly of FIG. 5 includes a plurality of openings 310, 506, and 508 to allow for the concurrent heating of bonding agent 304 coupled to plurality of electronic components 302, 502, and 504. Embodiments in accordance with the present invention are also well suited to sequentially utilizing each of a series of polymer substrate-protecting heat shielding fixtures to subject each location of bonding agent 304 to heat from a heat source. In one such embodiment, a first polymer substrate-protecting heat shielding fixture having less than three openings (e.g. only having openings 310 and 506 in front plane 308) is subjected to a heat source. In so doing, bonding agent 304 ultimately bonds electronic components 302 and 502 to polymer substrate 100. Next, a second polymer substrate-protecting heat shielding fixture having less than three openings (e.g. only having opening 508 in front plane 308) is subjected to a heat source. In so doing, bonding agent 304 ultimately bonds electronic component 504 to polymer substrate 100. Hence, embodiments in accordance with the present invention are well suited to using one or more polymer substrate-protecting heat shielding fixtures to subject a plurality of bonding agent locations to heat from a heat source.

As stated above, embodiments in accordance with the present invention enable polymer substrate 100 to be formed of materials such as, for example, polyethylene terephthalate (PET) or polyethylene naphthalate (PEN) which have a glass transition temperature which is less than the temperatures associated with SMT manufacturing processes. Additionally, in various embodiments in accordance with the present invention enable polymer substrate 100 is comprised of any of various thermo-plastic materials. As a result, embodiments in accordance with the present invention drastically reduce the costs associated with fabrication of flexible substrates. Specifically, by enabling the use of low temperature substrates such as, but not limited to PET and PEN, embodiments in accordance with the present invention derive the benefits of flexible substrates without incurring the increased costs associated with conventional flexible substrate material. Additionally, embodiments in accordance with the present invention derive the benefits of flexible substrates without requiring the failure-prone coupling of the flexible substrate to a rigid substrate. Instead, embodiments in accordance with the present invention enable an entire integrated circuit to be completely manufactured on a single contiguous sheet of low cost polymer material such as, for example, PET or PEN. Furthermore, PET and PEN have significant advantages associated therewith. In addition to being substantially less expensive than conventional polyimide materials (e.g. Kapton™ tape). Also, polyester materials such as PET and PEN are more easily recycled than polyimide materials. Also, PET and PEN can be made transparent.

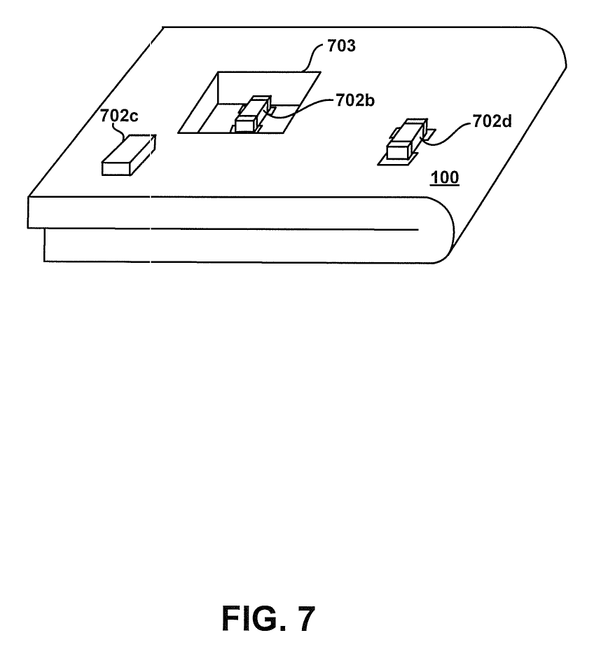

It should also be pointed out that embodiments in accordance with the present invention are also well suited to various other SMT processes. For purposes of brevity and clarity, FIGS. 3-6 generally depict the bonding of a two terminal device (e.g. electronic components 302, 502, and 504) to bonding pads coupled to polymer substrate 100 (comprised e.g. of PET or PEN). However, it is appreciated that embodiments in accordance with the present invention are well suited to utilizing an electronic component (as is illustrated in FIG. 7, 702c) bonded to any number of terminals. For example, integrated circuits with a variety of package types such as quad-flat pack (QFP), quad-flat no leads (QFN), or ball grid array (BGA) may be affixed to the substrate. Embodiments in accordance with the present invention are also well suited to utilizing a wire bonding SMT process to electrically couple an electronic component to polymer substrate 100. In one such approach, the wire bonding process is performed on a polyester substrate without requiring a rigid backing material, although the backing material may be used in some embodiments. Moreover, in such an embodiment in accordance with the present invention, the polyester substrate also withstands the deposition of an encapsulating material which is conventionally applied over the wire bonds used to electrically couple an integrated circuit die to bonding pads coupled to the polymer substrate. Also, embodiments in accordance with the present invention are also well suited to utilizing a flip chip SMT process to electrically couple an electronic component to polymer substrate 100. In one such embodiment, a heated die is used to cause an anisotropic conductive film to bond an integrated circuit to a plurality of corresponding bonding pads. Embodiments in accordance with the present invention clearly demonstrate that the polymer substrate (such as e.g. PET, PEN, or any of various thermoplastic materials) is able to withstand the heating associated with such an SMT process without causing the polymer substrate to suffer from curling, warping, or other unwanted deformation.

Referring now to FIG. 7, a perspective view of a polymer substrate 100 which is folded to produce a multilayer assembly is shown. As shown in FIG. 7, embodiments in accordance with the present invention are well suited to producing a multilayer assembly using polymer substrate 100 and the methods and structures discussed above in conjunction with the discussion of FIGS. 1-6. In the embodiment depicted in FIG. 7, polymer substrate 100 has a plurality of electronic components 702b-702d coupled thereto via a bonding agent utilizing the methods and structures discussed above in conjunction with the discussion of FIGS. 1-6. In the embodiment of FIG. 7, polymer substrate 100 has an opening 703 formed therein. Polymer substrate 100 can be folded over upon itself, as shown in FIG. 7, to create a multilayer assembly. In such an embodiment, opening 703, in polymer substrate 100, is used as an opening through which heat can be applied to an underlying electronic component such as, for example, electronic component 702b. That is, embodiments in accordance with the present invention are not limited to single layer polymer substrate assemblies. To the contrary, embodiments in accordance with the present invention (as were described above in detail) are well suited to creating multilayer assemblies using polymer substrate 100 in combination with conventional SMT processes. Multi-layer substrates are often made from substrates having fewer layers by lamination. An alternative is through folding.

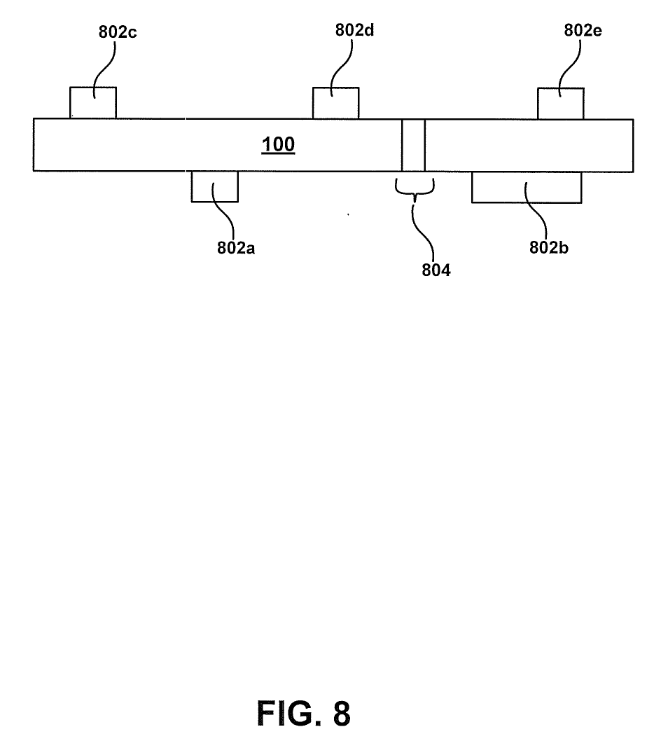

With reference now to FIG. 8, a side view of a polymer substrate 100 having electronic components coupled to both a first side and a second side of polymer substrate 100 is shown. In the embodiment of FIG. 8, electronic components 802a and 802b are disposed proximate a bonding agent, not shown, which is coupled to a first side of polymer substrate 100. Additionally, electronic components 802c, 802d, and 802e are disposed proximate a bonding agent, not shown, which is coupled to a second side of polymer substrate 100 wherein the second side of polymer substrate 100 is opposite the first side of polymer substrate 100. In one embodiment in accordance with the present invention, a conductive path is formed within through-hole 804 to readily enable electrically coupling one or more electronic components (802a and 802b) on the first side of polymer substrate 100 with one or more electronic components (802c, 802d, and 802e) on the second side of polymer substrate 100. The embodiment depicted in FIG. 8 is produced using polymer substrate 100 and the methods and structures discussed above in conjunction with the discussion of FIGS. 1-6. That is, embodiments in accordance with the present invention are not limited to disposing electronic components on only a single side of polymer substrate 100. To the contrary, embodiments in accordance with the present invention (as were described above in detail) are well suited to disposing electronic components on more than one side of polymer substrate 100 using conventional SMT processes.

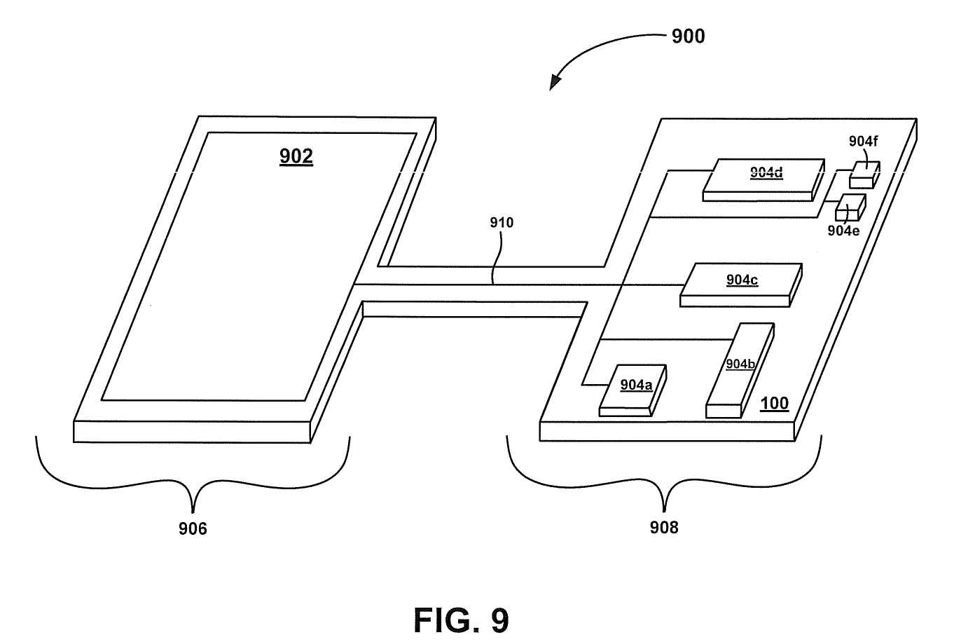

Referring now to FIG. 9, a perspective view of an electronic assembly 900 comprising a polymer substrate 100 having a capacitive sensing device 902 and a plurality of electronic components 904a-904f coupled thereto is shown. In the present embodiment, polymer substrate 100 is comprised of a polyester material (such as e.g. PET or PEN). Additionally, in various embodiments in accordance with the present invention, polymer substrate 100 is comprised of a thermo-plastic material. In the embodiment of FIG. 9, the capacitive sensing device 902 is disposed on a first region 906 of polyester substrate 100 and the plurality of electronic components 904a-904f are disposed on a second region 908 of polyester substrate 100. Additionally, in the embodiment of FIG. 9, the plurality of electronic components 904a-904f corresponds to capacitive sensing device 902. That is, the plurality of electronic components 904a-904f is comprised of components which operate in conjunction with capacitive sensing device 902. Capacitive sensing device 902 and the plurality of electronic components 904a-904f are coupled via conductive traces 910 coupled to polyester substrate 100. In the embodiment depicted in electronic assembly 900 of FIG. 9, the plurality of electronic components 904a-904f is coupled to polymer substrate using the methods and structures discussed above in conjunction with the discussion of FIGS. 1-6. Additionally, although a plurality of electronic components 904a-904f are shown in electronic assembly 900 of FIG. 9, embodiments in accordance with the present invention are also well suited to having only a single electronic component coupled to polyester substrate 100. Similarly, embodiments in accordance with the present invention are well suited to disposing electronic components on more than one side of polyester substrate 100 using conventional SMT processes.

Referring still to FIG. 9, electronic assembly 900 functions as an independently operational electronic assembly which is fully operational without requiring bonding of polyester substrate 100 to a rigid substrate. As a result, embodiments in accordance with the present invention drastically reduce the costs associated with fabrication of flexible substrates. Specifically, by enabling the use of low temperature substrates such as, but not limited to polyester substrates such as, for example, PET and PEN, embodiments in accordance with the present invention derive the benefits of flexible substrates without incurring the increased costs associated with conventional flexible substrate material (e.g. polyimide material such as Kapton™ tape). Additionally, embodiments in accordance with the present invention derive the benefits of flexible substrates without requiring the failure-prone coupling of the flexible substrate to a rigid substrate. Instead, embodiments in accordance with the present invention enable an entire flexible electronic assembly (such as a capacitive sensing device and its corresponding electronic components) to be completely manufactured on a single contiguous sheet of low cost polyester material such as, for example, PET, PEN or any of various other thermoplastic materials.

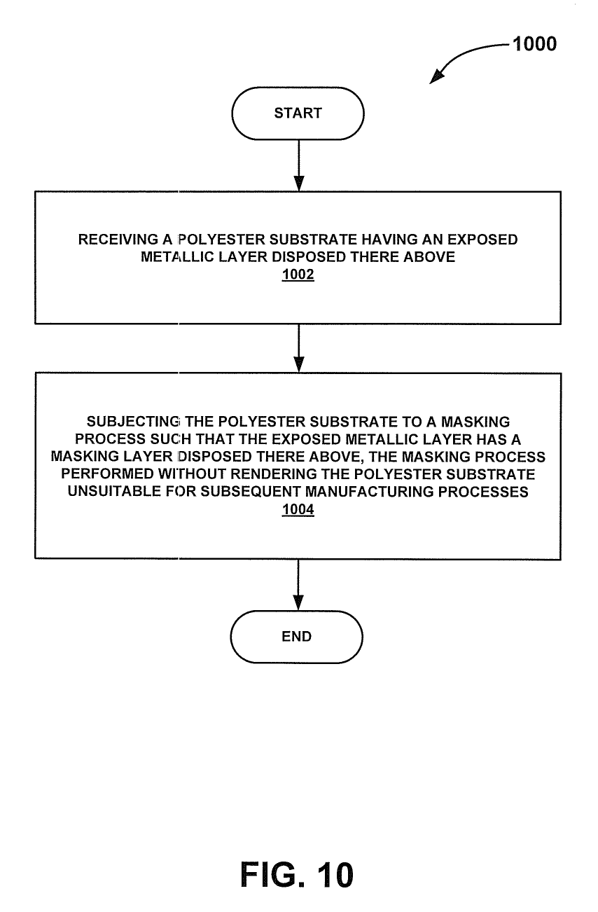

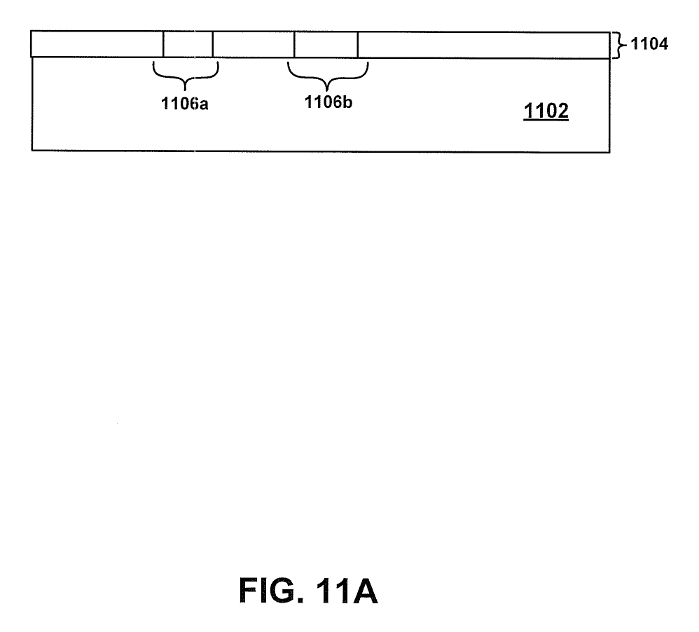

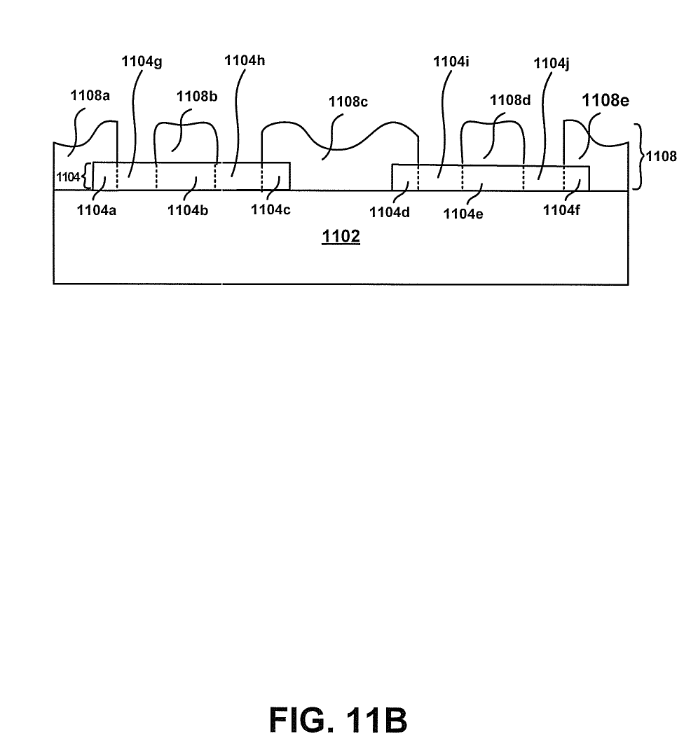

With reference now to FIG. 10, a flow chart 1000 describing a method for masking an exposed metallic layer disposed on a polyester substrate is provided. At 1002, the method of the present embodiment receives a polyester substrate 1002 having an exposed metallic layer disposed thereon. A depiction of a polyester substrate having a metallic layer 1104 disposed there above is provided in FIGS. 11A-11B which will be described further in conjunction with the discussion of flow chart 1000 of FIG. 10. FIG. 11A is a side view of polyester substrate 1102 having a metallic layer 1104 disposed there above, wherein metallic regions 1104g, 1104h, 1104i, and 1104j will ultimately remain exposed (i.e. unmasked). In the present embodiment, polyester substrate 1102 is comprised of a material such as, but not limited to PET or PEN. Additionally, in various embodiments in accordance with the present invention, polymer substrate 100 is comprised of a thermo-plastic material. It will be understood that the metallic layer can ultimately comprise, for example, a pattern of conductive traces, bonding pads, landing pads, and the like. Embodiments in accordance with the present invention are also well suited to performing the below-described masking processes on a polyester substrate having exposed metallic layers disposed above both sides (top and bottom side) of polyester substrate 1102.

Referring now to 1004 of FIG. 10 and also to FIG. 11B, the present embodiment subjects polyester substrate 1102 to a masking process such that exposed metallic layer 1104 has a masking layer (typically shown as 1108a, 1108b, 1108c, 1108d, and 1108e) disposed there above. Masking layer 1108a, 1108b, 1108c, 1108d, and 1108e is used to protect underlying portions of metallic layer 1104 (typically shown as protected portions 1104a, 1104b, 1104c, 1104d, 1104e and 1104f from, for example, subsequent SMT processes, exposure to the ambient environment, and the like.

In one embodiment, the masking process is a conventional masking process such as, for example, coverlay film lamination or a liquid photo-image-able (LPI) solder mask process. Conventional coverlay film lamination is applied a temperature of approximately 150 degrees Celsius. LPI solder mask processes are performed with an initial deposition step performed at a temperature of approximately 20-25 degrees Celsius. In the LPI solder mask process, the initial deposition step is followed by a curing step performed at a temperature of approximately 100 degrees Celsius. Hence, embodiments in accordance with the present invention enable polyester substrate 1102 to be formed of materials which previously were not possible to use as a substrate. That is, embodiments in accordance with the present invention enable polyester substrate 1102 to be formed of materials such as, for example, PET or PEN which have a glass transition temperature which is less than the temperatures associated with conventional metallic layer masking processes.

Referring still to 1004 of FIG. 10 and to FIG. 11B, it should be noted that embodiments in accordance with the present invention are able to perform the masking processes without rendering polyester substrate 1102 unsuitable for subsequent manufacturing processes. That is, embodiments in accordance with the present invention demonstrate that the polyester substrate (such as e.g. PET or PEN) is able to withstand the heating associated with such masking processes without causing the polyester substrate to suffer from curling, warping, or other unwanted deformation. It should be understood, that prior to the development of the embodiments of the present invention, it was not been possible, and was, in fact, believed to be impossible, to use materials such as PET and PEN in conjunction with masking processes such as coverlay film lamination and LPI solder mask processes. Hence, embodiments in accordance with the present invention enable polyester substrate 1102 to be utilized in masking processes which previously were thought to be incompatible with a low-temperature substrate such as PET, PEN, or any of various other thermoplastic materials. Conventional masking processes where found to cause curling, warping or other unwanted deformation of the polyester substrate. Hence the coverlay film lamination process uses tooling to maintain alignment during the lamination process at elevated temperature and pressure. Further, the LPI solder mask process selects an LPI solder mask material compatible with PET and PEN adhesion. The LPI solder mask material is preferably adhered using a temperature that does not cause curling, warping or unwanted deformation to the substrate. The LPI solder mask material is preferably selected so that it will survive the subsequent SMT process without damage.

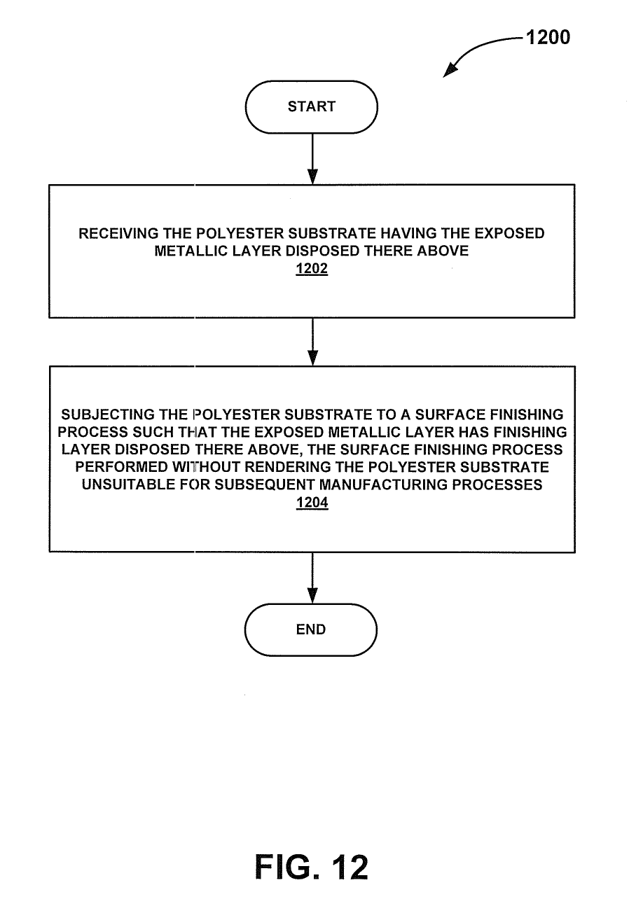

With reference now to FIG. 12, a flow chart 1200 describing a method for surface finishing an exposed metallic region disposed above a polyester substrate is provided. At 1202, the method of the present embodiment receives a polyester substrate having an exposed metallic layer disposed there above. A depiction of a polyester substrate having an exposed metallic layer disposed there above is provided in FIG. 11B. In the present embodiment, polyester substrate 1002 is comprised of a material such as, but not limited to PET or PEN. Additionally, in various embodiments in accordance with the present invention, polyester substrate 1002 is comprised of a thermo-plastic material. As discussed above, portions 1104g, 1104h, 1104i, and 1104j of metallic layer 1104 comprise exposed metallic regions. In one embodiment, metallic layer 1104 and, thus, exposed metallic regions 1104g, 1104h, 1104i, and 1104j are comprised of copper. It will be understood that the metallic layer can ultimately comprise, for example, a pattern of conductive traces, bonding pads, landing pads, and the like. Embodiments in accordance with the present invention are also well suited to performing the below-described masking processes on a polyester substrate having exposed metallic layers disposed above both sides (top and bottom side) of polyester substrate 1102. It will further be understood that copper is a chemically active metal which quickly oxidizes. Hence, if exposed metallic regions 1104g, 1104h, 1104i, and 1104j are not subjected to a surface finishing process, they will rapidly become unsuitable for subsequent soldering due to the oxidation thereof. Although metallic layer 1104 is described above as being comprised of copper, embodiments in accordance with the present invention are also well suited to use with metallic layers comprised of metal other than copper.

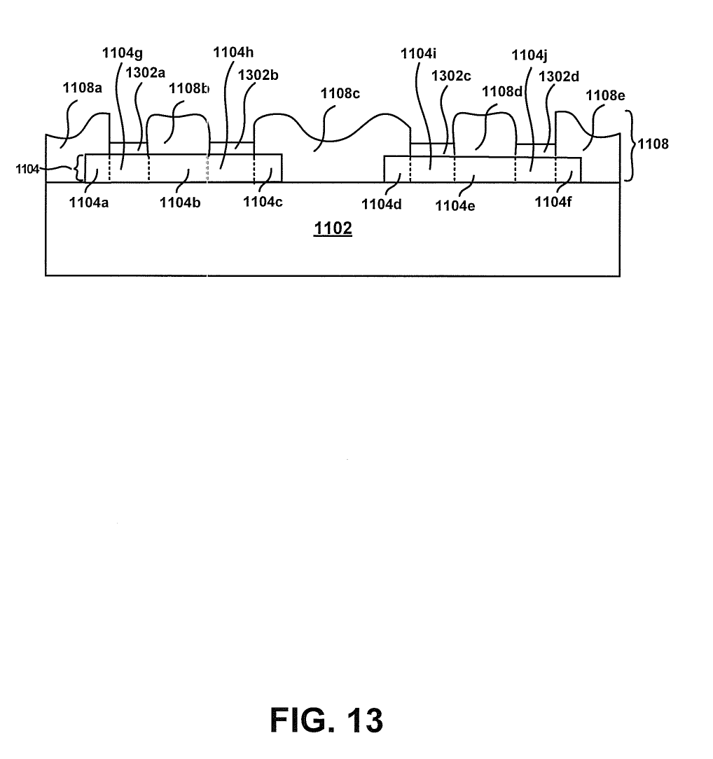

Referring now to 1204 of FIG. 12 and also to FIG. 13, embodiments in accordance with the present invention then subject polyester substrate 1102 to a surface finishing process such that exposed metallic regions 1106a and 1106b have finishing layer 1302a and 1302b, respectively, disposed thereon. Embodiments in accordance with the present invention are well suited to utilizing surface finishing processes such as, but not limited to, hot air solder level (HASL), immersion precious metal plating, and organic surface protectant (OSP). More specifically, embodiments in accordance with the present invention employ surface finishing processes such as, for example, electroless nickel immersion gold (ENiG), immersion tin, and immersion gold. Conventional processing conditions were found to damage the polyester substrate. Hence it is desirable create a finishing process so that the polyester substrate would not suffer from curling, warping or other unwanted deformation. This can be achieved by performing the process at a temperature that does not render the polyester substrate unsuitable for subsequent manufacturing processes. In another embodiment, the substrate is secured to a fixture to prevent curling, warping or other unwanted deformation during any elevated temperature processes.

Referring still to 1204 of FIG. 12 and to FIG. 13, it should be noted that embodiments in accordance with the present invention are able to perform the surface finishing processes without rendering polyester substrate 1102 unsuitable for subsequent manufacturing processes. That is, embodiments in accordance with the present invention demonstrate that the polyester substrate (such as e.g. PET or PEN) is able to withstand such surface finishing processes without causing polyester substrate 1102 to suffer from curling, warping, or other unwanted deformation. It should be understood, that prior to the development of the embodiments of the present invention, it was not possible, and was, in fact, believed to be impossible, to use materials such as PET and PEN in conjunction with surface finishing processes such as HASL, immersion precious metal plating, and OSP processes. Hence, embodiments in accordance with the present invention enable polyester substrate 1102 to be utilized in surface finishing processes which previously were thought to be incompatible with a low-temperature substrate such as PET, PEN, or other thermo-plastic material.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A method for fixedly and electronically coupling an electronic component to a polymer substrate, said method comprising:
receiving said polymer substrate having said electronic component disposed proximate a bonding agent coupled to said polymer substrate;
providing a heat shielding fixture configured to shield at least a portion of said polymer substrate from a single stage heat source, said heat shielding fixture configured to allow heat from said single stage heat source to access said bonding agent; and
subjecting said bonding agent to said single stage heat source such that said heat from said single stage heat source causes said electronic component to be fixedly and electronically coupled to said polymer substrate once said bonding agent solidifies.

2. The method as recited in claim 1 wherein said receiving said polymer substrate comprises:
receiving a polyester substrate having said electronic component disposed proximate a bonding agent coupled to said polyester substrate.

3. The method as recited in claim 2 wherein said polyester substrate is selected from the group consisting of:
polyethylene terephthalate and polyethylene naphthalate.

4. The method as recited in claim 1 wherein said receiving said polymer substrate comprises:
receiving said polymer substrate having said electronic component disposed proximate a bonding agent comprised of solder coupled to said polymer substrate.

5. The method as recited in claim 1 wherein said receiving said polymer substrate comprises:
receiving said polymer substrate having said electronic component disposed proximate a bonding agent comprised of low melting temperature solder coupled to said polymer substrate.

6. The method as recited in claim 1 wherein said providing a heat shielding fixture configured to shield at least a portion of said polymer substrate from a single stage heat source comprises:
providing a customized heat shielding fixture which is particularly configured to shield at least a portion of said polymer substrate from a single stage heat source while still allowing heat from said single stage heat source to access said bonding agent.

7. The method as recited in claim 1 wherein said providing a heat shielding fixture configured to shield at least a portion of said polymer substrate from a single stage heat source comprises:
providing a heat shielding fixture which is particularly configured to shield at least a portion of said polymer substrate from a single stage heat source while still allowing heat from said single stage heat source to access a plurality of locations on said polymer substrate at which electronic components are disposed proximate respective bonding agents coupled to said polymer substrate.

8. The method as recited in claim 1 wherein said method for fixedly coupling an electronic component to a polymer substrate is sequentially repeated for a plurality of electronic components disposed proximate a respective plurality of bonding agents disposed on said polymer substrate.

9. The method as recited in claim 1 wherein said receiving said polymer substrate having said electronic component disposed proximate a bonding agent coupled to said polymer substrate comprises:
receiving said polymer substrate having a first electronic component disposed proximate a bonding agent coupled to a first side of said polymer substrate, said polymer substrate having a second electronic component disposed proximate a bonding agent coupled to a second side of said polymer substrate.

10. The method as recited in claim 1 wherein said method for fixedly and electronically coupling an electronic component to a polymer substrate does not require subjecting said electronic component and said polymer substrate to an active cooling process subsequent to exposing said bonding agent to said single stage heat source.

11. The method as recited in claim 1 wherein said receiving said polymer substrate comprises:
receiving said polymer substrate having a stiffener structure coupled to a surface thereof.

12. The method as recited in claim 7 wherein said providing a heat shielding fixture configured to shield at least a portion of said polymer substrate from a single stage heat source comprises:
providing a heat shielding fixture having at least one additional opening formed therethrough for allowing coupling of an additional electronic component to said polymer substrate subsequent to said fixedly and electronically coupling of said electronic component to said polymer substrate.

13. A method for surface finishing an exposed metallic region disposed above a polyester substrate, said method comprising:
receiving said polyester substrate having said exposed metallic region disposed there above, said polyester substrate also having a masked metallic region disposed there above; and
subjecting said polyester substrate to a surface finishing process such that said exposed metallic region has a finishing layer disposed there above, said surface finishing process performed without rendering said polyester substrate unsuitable for subsequent manufacturing processes.

14. The method as recited in claim 13, wherein said receiving said polyester substrate having said exposed metallic region disposed there above comprises:
receiving said polyester substrate having said exposed metallic region comprised of a copper bonding pad disposed there above

15. The method as recited in claim 13 wherein said surface finishing process is selected from the group consisting of: hot air solder level (HASL), immersion precious metal plating, and organic surface protectant (OSP).

16. The method as recited in claim 13 wherein said receiving said polyester substrate having said exposed metallic region disposed there above comprises:
receiving said polyester substrate having said exposed metallic region disposed above a first side of said polyester substrate and having a second exposed metallic region disposed above a second side of said polyester substrate.

17. An electronic assembly comprising:
a polyester substrate; said polyester substrate comprising a first region and a second region;
a capacitive sensing device coupled to said first region of said polyester substrate; and
an electronic component fixedly and electronically coupled to said second region of said polyester substrate, said electronic component corresponding to said capacitive sensing device; said electronic component coupled to said capacitive sensing device via traces coupled to said polyester substrate.

18. The electronic assembly of claim 17, wherein said electronic assembly is an independently operational electronic assembly which is fully operational without requiring bonding of said polyester substrate to a rigid substrate.

19. The electronic assembly of claim 17 further comprising:
a second electronic component fixedly and electronically coupled to a side of said polyester substrate which is opposite from the side of said polyester substrate on which said second region is disposed.

20. A polymer substrate-protecting heat shielding fixture comprising:
a back plane, said back plane configured to shield at least a portion of a back surface of a polymer substrate from heat generated by a single stage heat source;
a front plane, said front plane configured to shield at least a portion of a front surface of a polymer substrate from heat generated by said single stage heat source, said front plane configured to allow heat from said single stage heat source to access a bonding agent disposed on said polymer substrate; and
an alignment mechanism configured to align said back plane and said front plane, said polymer substrate-protecting heat shielding fixture configured to be aligned together to enclose a polymer substrate between said front plane and said back plane such that said polymer substrate-protecting heat shielding fixture provides structural rigidity to said polymer substrate during heating thereof.

21. A method for masking an exposed metallic layer disposed above a polyester substrate, said method comprising:
receiving said polyester substrate having said exposed metallic layer disposed thereon; and
subjecting said polyester substrate to a masking process such that said exposed metallic layer has a masking layer disposed there above, said masking process performed without rendering said polyester substrate unsuitable for subsequent manufacturing processes.

22. The method as recited in claim 21 wherein said masking process is selected from the group consisting of: coverlay film lamination and liquid photo-image-able (LPI) solder mask processes.
